(19) United States
(12) Patent Application Publication
(10) Pub. No.: US 2002/0027984 A1
(43) Pub. Date: Mar. 7, 2002

(54) Filter

(75) Inventor: Harri Elo, Helsinki (FI)

Correspondence Address: Michael C. Stuart, Cohen, Pontani, Lieberman & Pavane, Suite 1210, 551 Fifth Avenue, New York, NY, 10176, US

(73) Assignee: Nokia Networks Oy

(21) Appl. No.: 09/891,021

(22) Filed: Jun. 25, 2001

(30) Foreign Application Priority Data
Jun. 27, 2000 (FI) 20001521

(51) Int. Cl. H04M 1/00; H04M 3/00

(52) U.S. Cl. 379/377; 379/399.01

(57) ABSTRACT

A filter according to an embodiment of the invention actively adapts terminal equipment and a subscriber line to each other by conforming to the electric properties of the subscriber line. Then the filter virtually changes the electric properties of the subscriber line more advantageous for the terminal equipment.

The invention relates to fast, digital data transfer along ordinary telephone lines. In particular, the invention relates to the separation of frequency bands used by an xDSL terminal device and a POTS terminal device in the subscriber line of an ordinary telephone.

The implementation of the coupling of the wired telephone network and the telephone sets is slightly different in different countries. This is why a telephone set, which functions in one country does not function directly in another country without some additional coupling, which is costly and time-consuming and can only be done by a specialized person. As a result of this, various accessories, such as applications used in data transfer, cannot function at the intended rate, but the user may have to use ordinary, slower connections instead of the intended application.

The development in the field has produced Digital Subscriber Line techniques, referred to as DSL later in this document, which can be used in public switched telephone networks (PSTN) at multiple rates compared to ISDN or voice frequency modems. The DSL techniques are further divided into subgroups, such as ADSL and VDSL, which, however, have some features in common, and therefore it is possible to use the general term XDSL, which comprises the ADSL and VDSL techniques.

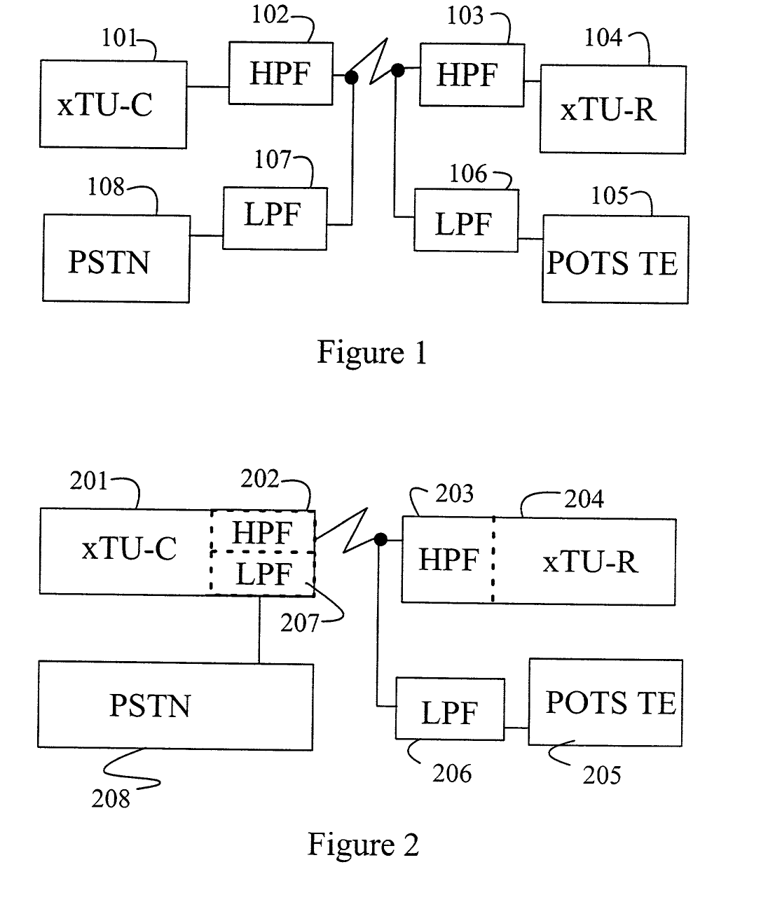

ADSL and VDSL share the common feature that the signal band is limited to a frequency range, which enables frequency multiplexing of the audio frequency and XDSL connection to the same subscriber line. Then the lower limiting frequency of XDSL is clearly above the audio frequency band, 4 kHz. Because the PSTN is not entirely band-limited, and neither is XDSL, it is necessary to use separating filters like the ones shown in FIG. 1.

In FIG. 1, there is a High Pass Filter (HPF) coupled between an xDSL Terminating Unit-Central office (xTU-C) and a subscriber line. A Low Pass Filter (LPF) is coupled between the PSTN (Public Switched Telephone Network) and the subscriber line. Correspondingly, at the subscriber's end there is a high pass filter coupled between an xDSL Terminating Unit-Remote end (xTU-R) and the subscriber line, and a low pass filter is coupled between a Plain Old Telephone System (POTS) and the subscriber line. The subscriber's POTS Terminal Equipment (POTS, TE) can be, for example, a telephone modem or a modem of an optional network.

In filter design, the purpose is to accomplish as good separation as possible between the audio interface and xDSL from DC up to the upper limit of the xDSL band. In practice, the separation is sufficient when the joint effect of LPF and HPF is at least 40 dB at all frequencies. At the subscriber's end, the LPF is generally placed as shown in FIG. 2, mechanically separately outside the xTU-R. The HPF is advantageously integrated into the xTU-R. At the exchange end, the LPF can also be integrated into the same circuit board as the xTU-C and the HPF, but this is not necessary: there are also implementations, in which the xTU/HPF combinations are placed in different boards than the LPFs. However, the LPF at the subscriber's end is the primary concern of this document. The term longitudinal refers to a coupling in series with one of the wires, or both, and transverse refers to a coupling between, or in parallel with the wires of the twin cable of a telephone line.

A new technique to be used beside the coaxial cable connections in the transmission of Internet connections is the planned XDSL technique, which allows installation of the connection without the technical support of the operator. A technique like this is the standardized G.992.2 or “splitterless ADSL”, which requires a large number of filters, in spite of its name.

In G.992.2, the idea was to drop the transmission power of xTU-R to a level, which does not cause disturbance to audio frequency terminal equipment. xTU-C also transmits on a lower level and narrower band than ADSL. When necessary, a “microfilter” has been installed for the subscriber at each telephone connection, which is disturbed by the xDSL line. The microfilter is generally a simple LPF. Later in this document, this will be referred to as a “POTS filter” or merely as a “filter”.

There are some problems related to the transmission method of G.992.2. When the transmission power is dropped, the data rate drops, too. The maximum transfer rate of G.992.2 is only a fraction of the corresponding rate in ADSL. In addition, because microfilters are needed, as well as separate installation thereof, lowering of power levels etc., it is very likely that problems will occur when this technique is applied to the requirements of different users.

The use of line telephones and the coupling thereof in one location where the number of telephones can be substantial, sometimes as much as half a dozen even in a private household, includes various aspects which have an effect on the quality of the telephone and xDSL services. Line telephones, as well as the filters used with them, are electrically coupled in parallel, whereby the audio frequency and the load on the xDSL line increases in proportion to the number of filters and telephone sets in the coupling.

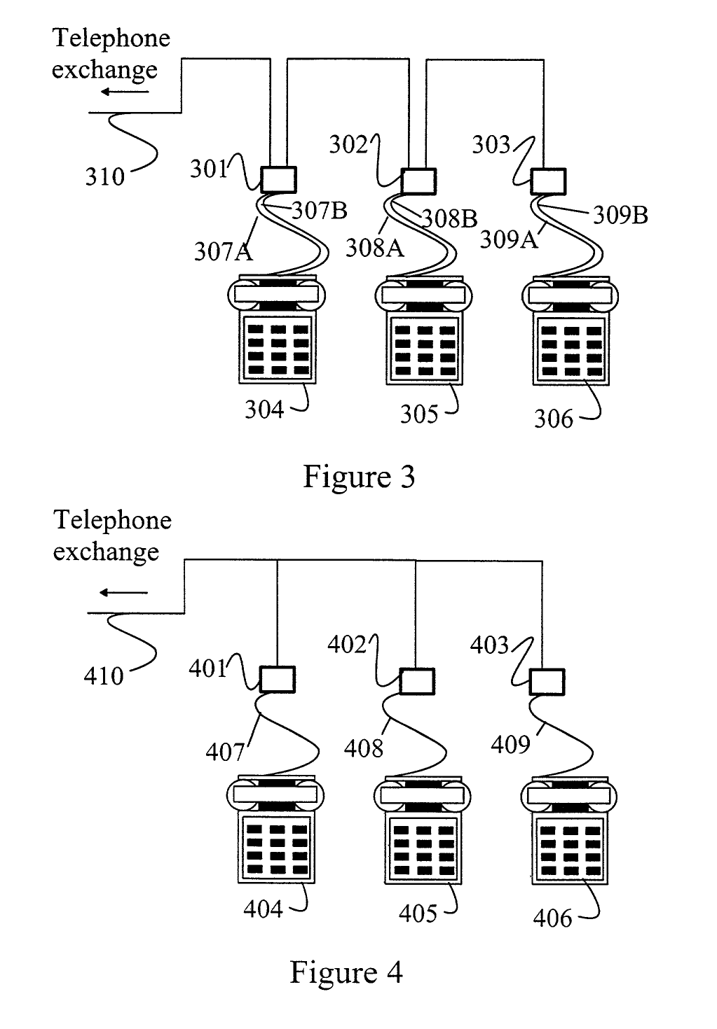

The couplings of telephone networks in house network solutions can be divided into two main types, which are shown in FIGS. 3 and 4. FIG. 3 shows the coupling of telephone sets to the line network in twin pairs, which is not a problem with regard to the POTS filter to be installed. In these networks, the cabling has been implemented so that two pairs of conductors are brought to each terminal equipment: the pair coming from the outlet and the pair returning to it. The installation of a POTS filter requires that the pair of conductors going to the terminal equipment is cut, which has been done already, because the pair inside the building has been cut. It is not necessary for the subscriber to ask the teleoperator for help in the installation of the filter, if the filter supports the mechanical plug solutions. Installing the filter is then as easy as plugging in a telephone set.

In the star network solution shown in FIG. 4, the telephones are coupled with single pairs. In the coupling method with single cables, the cables cannot be reached by the subscriber, and for obvious reasons, the teleoperators do not allow the subscribers access to the distributing cabinets of the houses. In a case like that, it is necessary to use terminal-specific filters, i.e. one for each telephone set, for installing the xDSL without the operator's support.

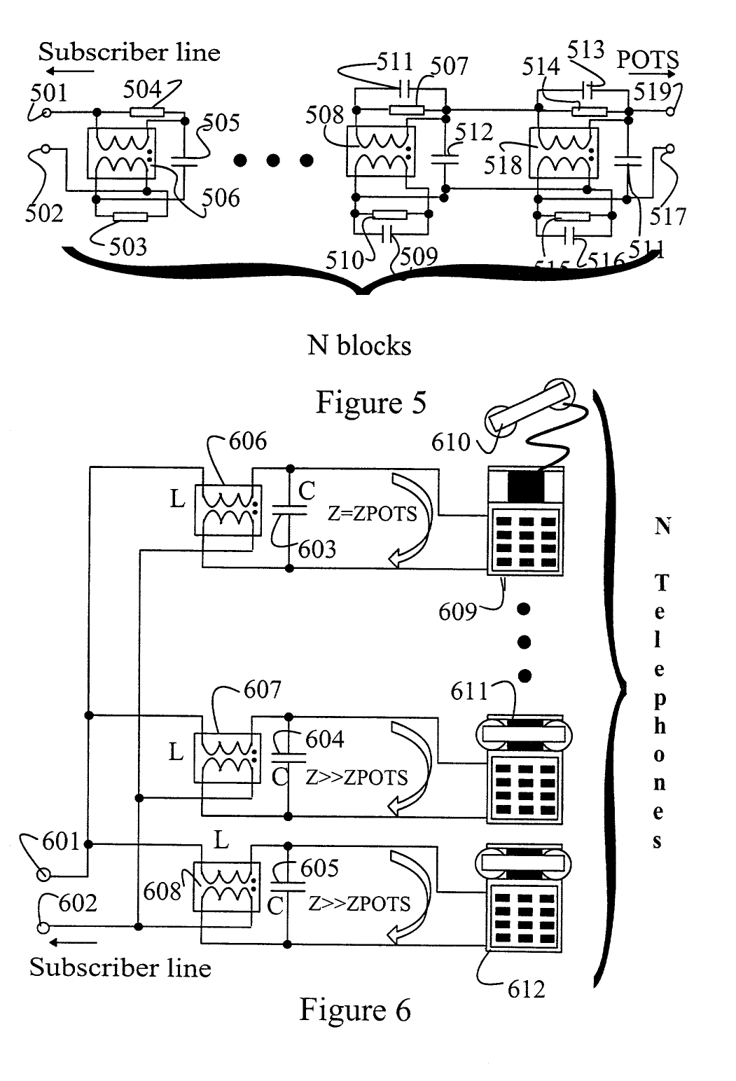

FIG. 5 shows a generalized filter topology, which is valid in the passive POTS filters of all manufacturers in the cases of ADSL, VDSL and G.lite. The filter includes N blocks, each of which contains at least one longitudinal inductance (implemented with a transformer). In addition, the block may include i) a longitudinal capacitance, ii) a longitudinal resistance, iii) a transverse capacitance, and combinations of these. The only exception is the first block as viewed from the line connection (which is connected in parallel with the xDSL terminal device), which may not be equipped with longitudinal line capacitance.

FIG. 6 shows a parallel coupling of a telephone set in the current applications that comply with the single-pair network topology. In this coupling, a number of POTS filters corresponding to the number N of telephones is installed for the subscriber. The filter shown as an example in the drawing is extremely simple, containing only one longitudinal inductance L and transverse capacitance C. In a telephone set shown in the drawing, the handset has been lifted and the circuit thus closed via ZPOTS (=the internal impedance of the telephone). Even a single filter makes the subscriber line look somewhat different to the telephone set than before the installation of xDSL. However, the other N−1 filters that stay coupled in parallel with the telephone in operation cause a problem. Their equivalent circuit is a series resonator with a resonance frequency f, which is

$$f = \frac{1}{2 π \sqrt{LC}} \qquad ( 1 )$$

This frequency can be easily placed between the audio and xDSL bands, but the situation is still problematic.

In the audio band, the unloaded filters are essentially seen as the capacitance (N−1)C, which is thus formed of parallel capacitances. If the number of telephones is high, the total capacitance is also high. In practice, N=3 is already a high, problematic number of telephones. The situation is made even worse by the fact that the xDSL modem (in practice, its HPF, which is placed in the line connection) is seen on the audio band as the capacitance C_{xDSL}. The unloaded filters are seen on the xDSL band as the inductance L/(N−1), which is too small a value, even if an individual inductance were sufficient. Too small L loads the xDSL modem. The objective of the invention is to reduce the load caused by the XDSL modem and the equipment on the audio band and to improve the applicability of the xDSL in the star network topology.

The principle of the invention is to optimize the connection of the terminal equipment to the telephone line with the filter according to the invention.

The objectives of the invention are achieved with the POTS filter, which has an active embodiment.

The filter according to the invention is characterized in what is set forth in the characterizing part of claim 1. The method according to the invention for adapting the terminal equipment to the subscriber line is characterized in what is set forth in the characterizing part of claim 21. By the filter according to the invention, the POTS filter, the terminal equipment can be adapted to the telephone line so that the entity formed by the filter and the terminal equipment loads the telephone line only a little in spite of a large number of filters according to the invention coupled in parallel to the telephone line.

The invention is implemented in embodiments, in which the common feature is a filter, which modifies its own electric properties according to need to optimize the coupling of the terminal equipment to the subscriber line, and in an embodiment, which provides a method for this purpose. The filter according to the embodiment of the invention includes an electric circuit, which is coupled in parallel with the subscriber line of the telephone, transversely (from the first conductor of the cable pair in the subscriber line to the second conductor), according to the status of the telephone line.

In the embodiments of the invention, switching is automatic, and the need to connect or disconnect the electric circuit can be determined by the filter electronics on the basis of the reference values. Then the circuit is included in the filter as a part, which is switched on or off the line parallel with the subscriber line on the basis of current and/or voltage measured by equipment integrated in the filter. With regard to use with XDSL, at the simplest the circuit switched by the filter can be a capacitor, and the filtering properties of the filter can be changed by means of its switchable capacitance. The circuit can also include other components to improve its filtering properties. These other components can be inductive, such as coils or the like, which have an inductance typical of the electronics used on the frequency band of the terminal equipment. In addition, this circuit may include resistors for optimizing the RCL properties of the circuit and/or optimizing the direct current load. It is also possible to use semiconductors to adapt the electric properties of the switchable circuit so that they correspond to the desired frequency band. The switchable circuit can also be selectable from a number of alternatives according to the quality of the XDSL terminal equipment.

In the following, the invention will be described in more detail with reference to the examples of preferred embodiments and the accompanying drawings, in which

FIG. 1 shows a diagram of the coupling of xDSL and POTS to a common subscriber line.

FIG. 2 shows a diagram of the physical placement of the filters.

FIG. 3 shows a coupling of terminal equipment with a twin pair,

FIG. 4 shows a coupling of terminal equipment with a single pair,

FIG. 5 shows a generalized coupling of filters,

FIG. 6 shows a parallel coupling of telephones in the topology of a single-pair network,

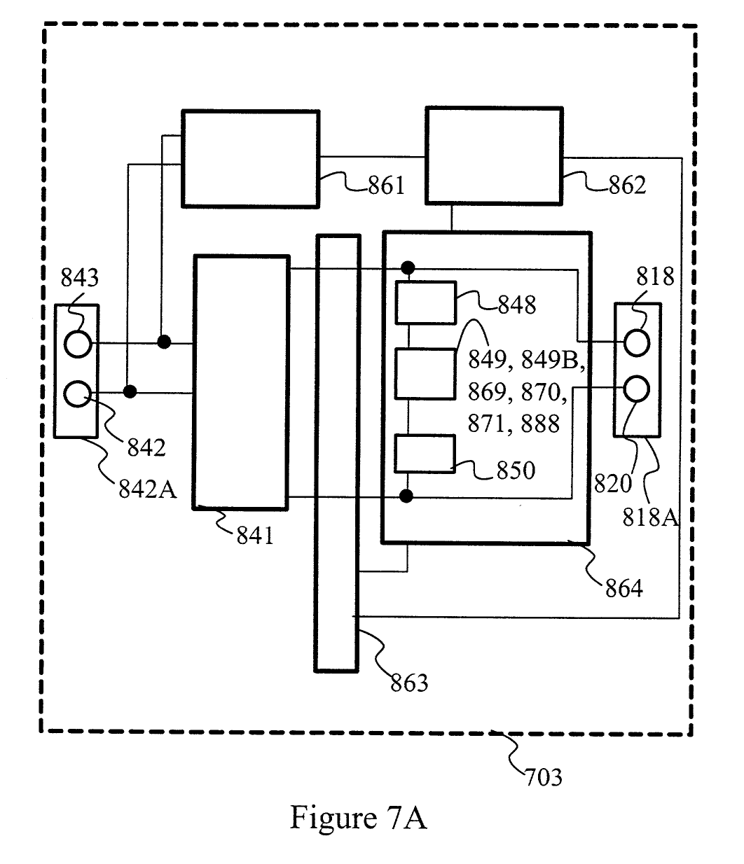

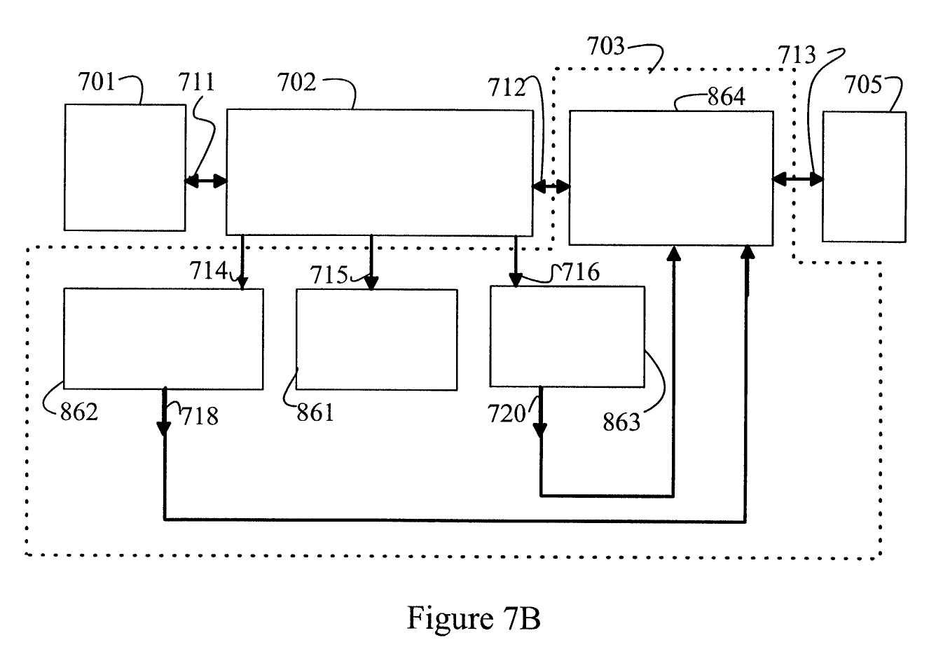

FIG. 7A shows the basic structure of a microfilter according to an embodiment of the invention,

FIG. 7B shows the basic operation of a microfilter according to an embodiment of the invention,

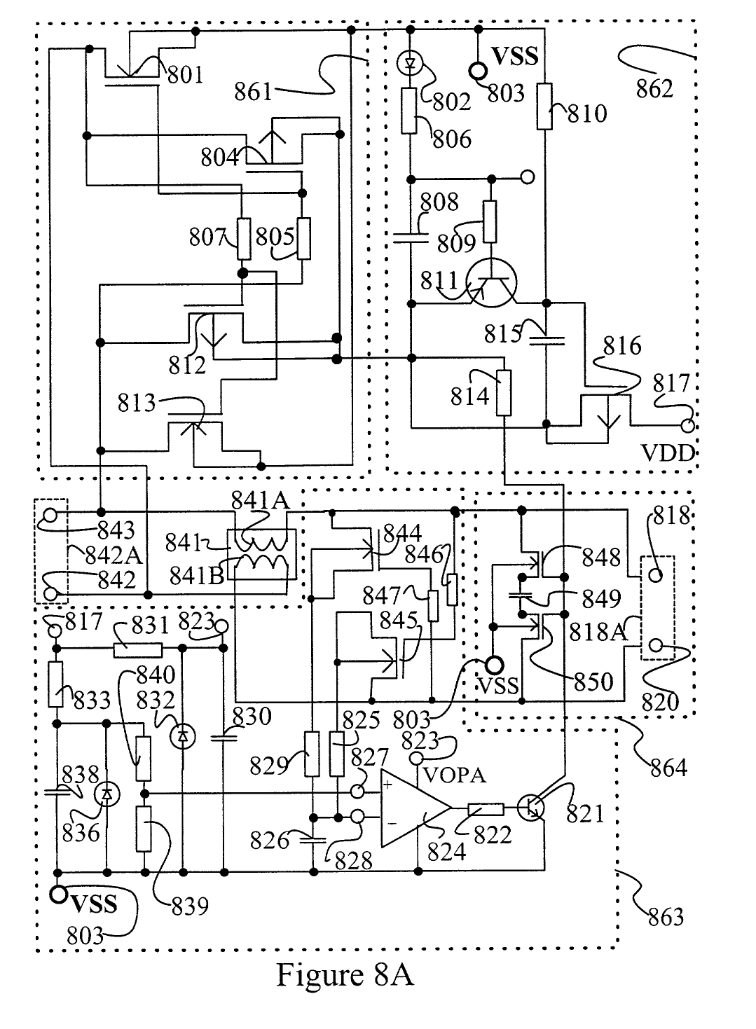

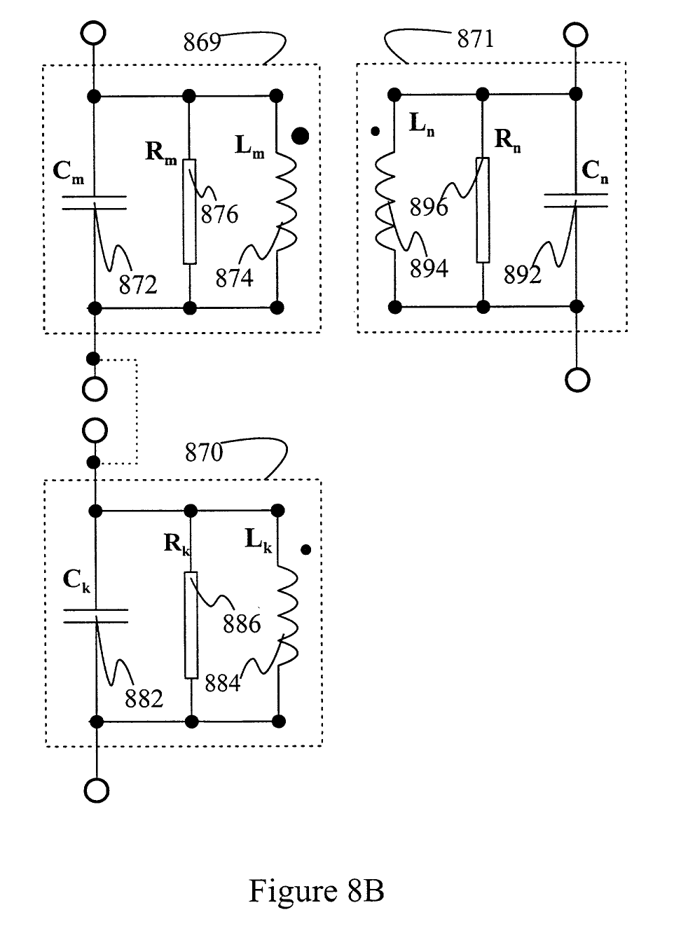

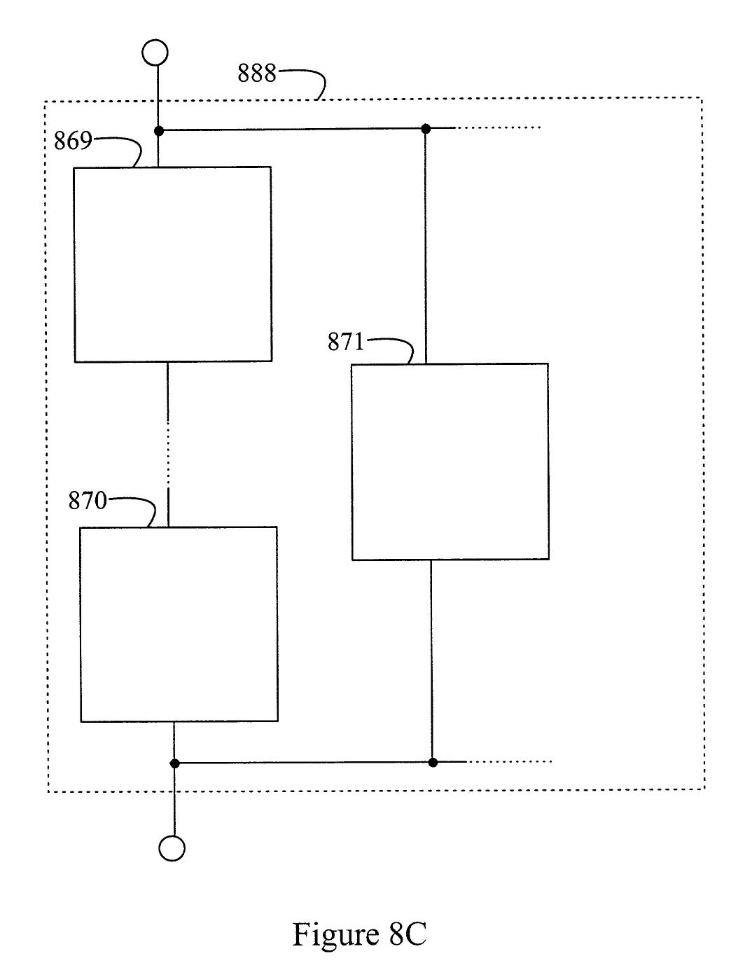

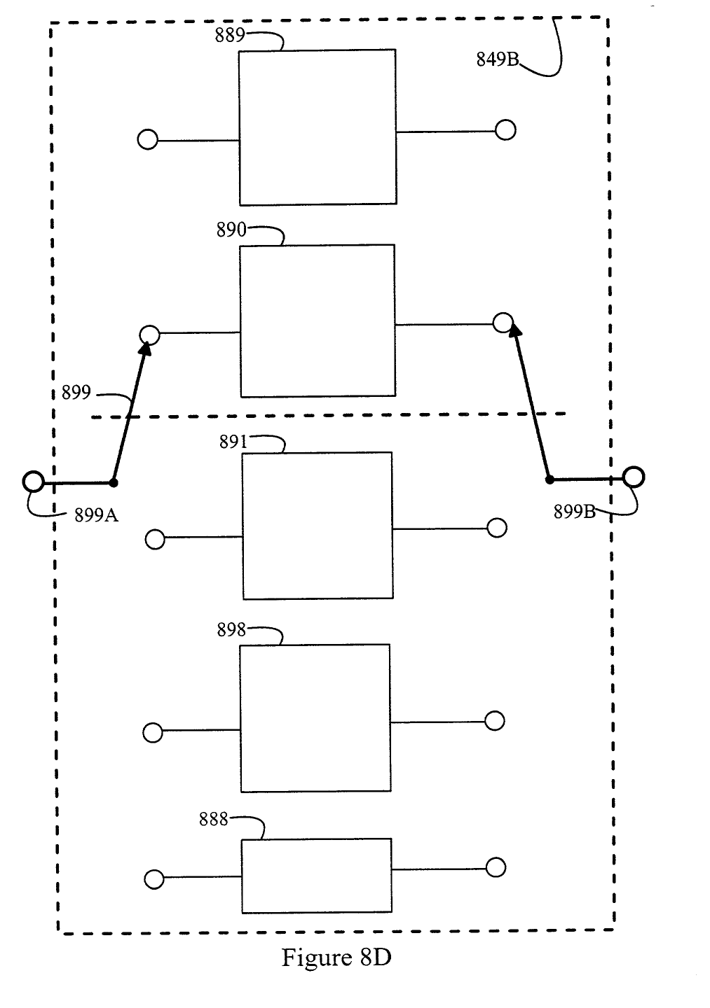

FIG. 8A shows a circuit diagram of an active filter according to one embodiment of the invention,

FIG. 8B shows the RCL structure of an auxiliary circuit of an active filter according to an embodiment of the invention,

FIG. 8C shows the RCL switching topology of the auxiliary circuits according to an embodiment of the invention,

FIG. 8D illustrates a functional filter circuit for use as an auxiliary circuit according to an embodiment of the invention.

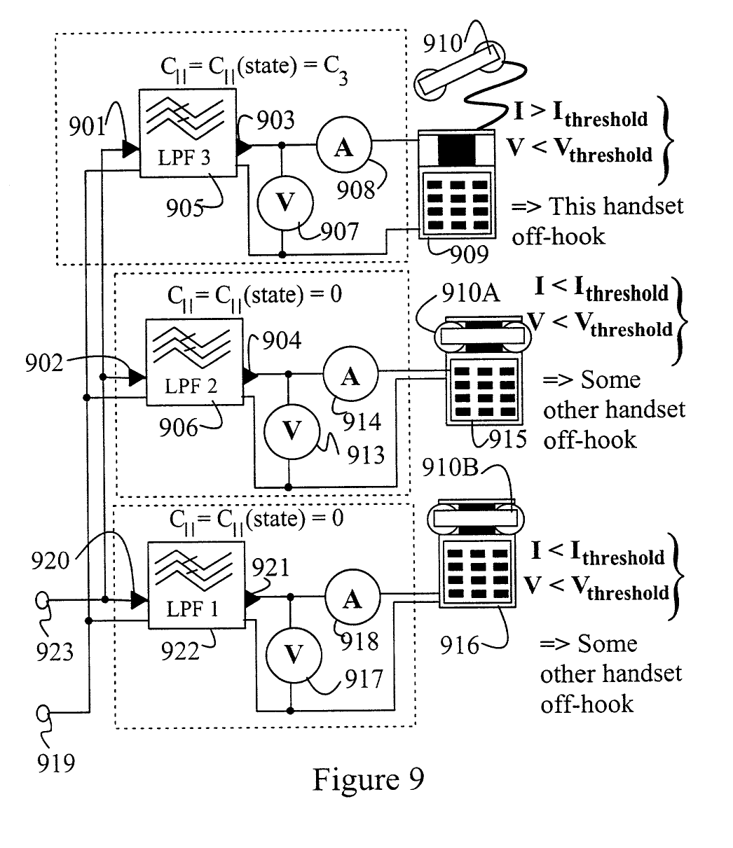

FIG. 9 illustrates the principle of operation of an active microfilter according to an embodiment of the invention.

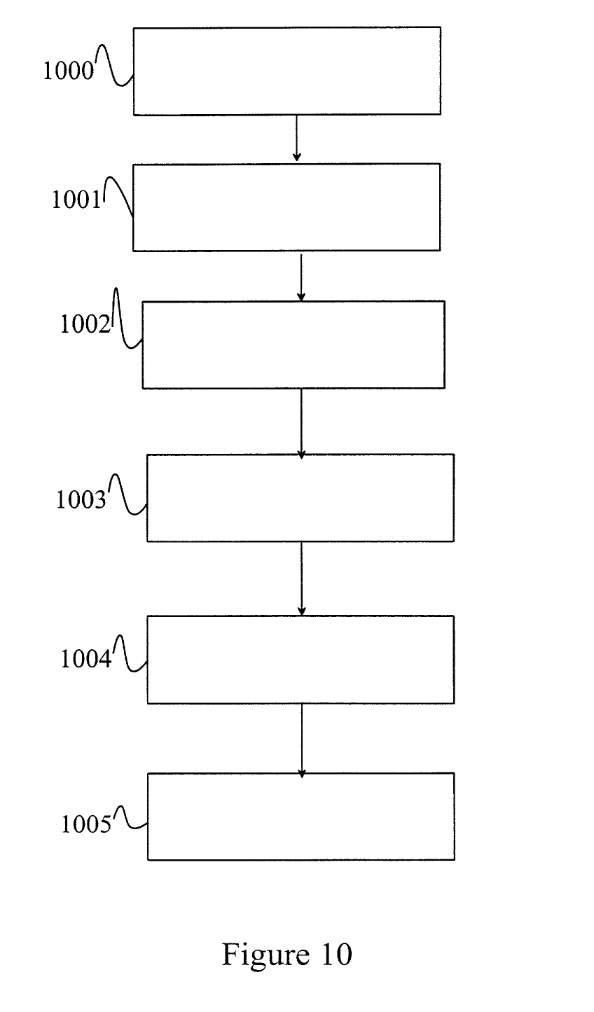

FIG. 10 shows a method according to an embodiment of the invention for virtually changing the electric properties of the subscriber line.

Above in connection with the description of the prior art and its characteristics, reference was made to FIGS. 1 to 6, which represent the prior art and its characteristics, and thus in the following description of the invention and its preferred embodiments reference will be made mostly to FIGS. 7A to 10. The embodiments of the invention are illustrated in FIGS. 7A to 10. Between different Figure, the same indexes will be used for corresponding parts.

FIG. 7A illustrates the structure of a filter according to some embodiments of the invention on a basic level. The filter 703 includes a connection 842 A for connecting the cable pair of the subscriber line to the filter via the contacts 842 and 843. The filter also includes a connection 818A for connecting the terminal equipment to the filter by means of the contacts 818 and 820. The filter 703 includes a rectifier block 861, the purpose of which is to provide operating power for other parts of the filter circuit 703 as well. Block 862 is the line voltage measurement block. Block 863 is the line current measurement block. The active capacitance of the filter is in block 864, which essentially includes switching means 848 and 850 for switching the switchable capacitor 849 and/or its auxiliary circuit 869, 870, 871, 888 or 849B to adapt to each other the subscriber line, to be coupled to the connection 848A, and the terminal equipment to be coupled to the connection 818A, in the most advantageous manner for each according to the invention. The switchable capacitance 849 and/or auxiliary circuit 869, 870, 871, 888 or 849B and the switching means 848 and 850 can also be located in some other part of the filter, by forming a structure according to the one presented in block 864, in parallel with the subscriber line, transversely to it, which is obvious to a person skilled in the art. The properties of the auxiliary circuits according to the embodiments of the invention will be described later in greater detail.

FIG. 7B illustrates the operation of a filter according to an embodiment of the invention for advantageously adapting the terminal equipment 705 to the subscriber line 702 of the telephone line 701 by changing the electric properties of the filter active according to the state of the telephone line. According to the embodiment of the invention, the polarity of the telephone network 701 is recognized 715 from the subscriber line 702 by means of an active rectifier block 861 for providing operating power to the filter. In addition, the line voltage is measured 714 and the line current is measured 716 by means of the blocks 862 (voltage measurement block) and 863 (current measurement block). On the basis of the measured currents and voltages and reference values, the circuit 864 is controlled 718, 720 for changing the electric properties. The changes caused by the operation of the terminal equipment 705 are seen in the line current and voltage of the subscriber line, and the POTS filter 703 adapts to the changes by switching the electric circuit contained by the circuit 864 on or off. Blocks 861, 862, 863 and 864 will be described later in connection with FIG. 8A.

FIG. 8A shows an active microfilter, for which operating power is provided by the telephone line. Terminals 842 and 843 provide the connection to the subscriber line, and terminals 818 and 820 to the terminal equipment. FIG. 8A shows semiconductors of which 801, 813, 844, 845 and 850 are n-type MOSFETs, and 804, 812 and 816 are p-type MOSFETs. From now on, these components will be referred to as fets, accompanied by the relevant number. With the exception of fets 848 and 850, the other fets have the Body terminal and the Source terminal connected together. The circuit of an active filter will be described in the following. In FIG. 8A the connector 843 is coupled to the first end of coil 841 A of the transformer 841. The second end of coil 841A is connected to the Drain terminal of fet 844, to the first end of resistor 846, to the Drain terminal of fet 848 and the connector 818. In addition, the first end of coil 841A is connected to the Drain terminals of fets 813 and 812 and the second end of resistor 805. The Drain terminal of fet 801 and the first end of resistor 807 and the Drain terminal of fet 804 are connected to the terminal 842. The Gate terminals of fets 813 and 812 are connected to each other, and the point of connection is connected to the second end of resistor 805. The Gate terminal of fet 801 is connected to the Gate terminal of fet 804 and to the first end of resistor 805. The Source terminals of fets 801, 813 are connected to each other. The Source terminals of fets 804 and 812 are also connected to each other. In addition, the Source terminal of fet 801 is connected to the first end of zener diode 802, its anode, to the first end of resistor 810 and to the second voltage supply terminal 803 (VSS) of the microfilter.

The second end of zener diodes 802 is connected to the first end of resistor 806. The second end of the resistor 806 is connected to the first end of the capacitor 808 and to the resistor 809. The second end of capacitor 808 is connected to the emitter of the pnp transistor 811, to the first end of resistor 814, to the Source terminal of fet 812, to the capacitor 815 and the Source terminal of fet 816. The first end of capacitor 815 is connected to the collector of pnp transistor 811 and to the second end of resistor 810. The second end of resistor 809 is connected to the base of transistor 811. The second end of resistor 814 is connected to the Gate terminals of fets 848 and 850 and to the collector of npn transistor 821. The Gate terminal of fet 816 is connected to the collector of transistor 811 and to the first end of capacitor 815. The Drain terminal of fet 816 is connected to the terminal 817 (VDD). The Source terminal of fet 848 is connected to the first end of capacitor 849, and the second end of capacitor 849 is connected to the Source terminal of fet 850. In addition, the Body terminals of fets 848 and 850 are coupled together and connected to the second voltage supply terminal 803.

The second end of the second coil 841B of the transformer 841 is connected to the connecting terminal 842. The first end of coil 841B is connected to the Drain terminal of fet 845, to the second end of resistor 847, to the Drain terminal of fet 850 and connector 820. The first end of resistor 847 is connected to the Gate terminal of fet 844. The second end of resistor 846 is connected to the Gate terminal of fet 845. The Source terminal of fet 844 is connected to the first end of resistor 829. The second end of resistor 829 is connected to the first end of capacitor 826, to the second end of resistor 825, to the terminal 828 and to the inverting input of the operational amplifier 824. The first end of resistor 825 is connected to the Source terminal of fet 845. The second voltage supply terminal of the operational amplifier 824 is connected to the second voltage supply terminal 803. The first voltage supply terminal of the operational amplifier 824 is connected to terminal 823 (VOPA). The output terminal of the operation amplifier is connected to the first end of the resistor 822, and the second end of the resistor 822 is connected to the base of npn transistor 821. The emitter of transistor 821 is connected to the second voltage supply terminal (VSS) 803 of the filter. This voltage supply terminal VSS 803 is also connected to the second end of the capacitor 826, to the second end of the capacitor 830, to the anode of the zener diode 832 from the second end of the zener diode, to the second end of resistor 839, to the anode of zener diode 836 and to the second end of capacitor 838.

The first end of resistor 839 is connected to the non-inverting input of operational amplifier 824, the terminal 827 and the second end of resistor 840. The first end of resistor 840 is connected to the first end of zener diode 836, to the first end of capacitor 838 and the second end of resistor 833. The first end of resistor 833 is connected to the terminal 817, the potential of the operating voltage VDD, and to the first end of resistor 831. The second end of resistor 831 is connected to the first end of zener diode 832, the first end of capacitor 830 and the positive operating voltage 823 of the operational amplifier 824.

There are a number of functional blocks in the coupling shown in FIG. 8A: active rectifier 861, voltage meter 862, current meter 863 and a block 864 that forms an active capacitance. These blocks are marked with dashed lines in the drawing. Block 861 comprises an active rectifier, for which operating power is provided by the telephone line connected to terminals 842 and 843. If the potential of terminal 843 is higher than that of terminals 842, fets 801 and 812 conduct. As a result of this, the second voltage supply terminal 803 of the filter is coupled to the terminal 842 via fet 801 and the source electrode of fet 816 is coupled to terminal 843. If it is recognized that one of the handsets of the subscriber's telephones is off-hook, fet 816 connects the VDD terminal 817 to terminal 843, or the twisted pair to the conductor which has the higher potential. If the potential of terminal 842 is higher than that of terminal 843, the coupling operates the other way round. Then fet 813 conducts and connects terminal 843 to the second voltage supply terminal 803 of the equipment. When fet 804 conducts, the Source terminal of fet 816 is connected to terminal 842, in the off-hook mode fet 816 conducts and thus also connects terminal 842 to terminal VDD 817. If all the subscriber's handsets are on-hook, fet 816 does not conduct, and thus the current meter does not load the line.

Block 862 functions as a voltage meter, for which the reference voltage is provided by zener diode 802. In the on-hook mode, the capacitor 808 is charged to a high voltage, as a result of which the transistor 811 is in a conducting mode, whereby the gate control of fet 816 is prevented and fet 816 does not conduct. When transfer to the off-hook mode takes place, the voltage over the zener diode 802 falls and the zener diode stops conducting, the capacitor 808 begins to discharge via the resistor 809 and the base-emitter junction of the transistor 811. When the capacitor 808 has been discharged, the transistor 811 stops conducting. Thus the capacitor 815 can be charged via the resistor 810, whereby it also causes fet 816 to conduct, whereby the one of the terminals 842 or 843 with the higher potential is connected to terminal 817, VDD. The output VDD of the voltage meter 862, terminal 817, has two modes. In the off-hook mode, the voltage of terminal 817 depends on the voltage of the subscriber line. In the on-hook mode, terminal 817 is left to float in relation to the voltage meter, i.e. the supply of current to the current meter is switched off.

The current meter block 863 functions by measuring the DC voltage, left over the transformer's 841 coils which voltage is directly proportional to the DC component of the line current. The reference for the current meter is provided by the zener diode 836 and the resistors 839 and 840. The operational amplifier 824 functions as a comparator, which compares the voltages of points 827 and 828. When the voltage of input 827 is higher than that of input 828, the circuit recognizes that its own telephone is in the on-hook mode. The output of the comparator then rises and causes the transistor 821 to conduct, as a result of which the gates of fets 848 and 850 are coupled to the second voltage supply terminal (VSS) of the device. The capacitor 849 floats and does not load the line. When the voltage of input 828 is higher than that of input 827, the operation is reverse to that described above, whereby the transistor 821 is in the non-conducting mode, and the gates of fets 848 and 850 are led to the conductive mode. Then there is coupled between the connectors 818 and 820 of the POTS filter the capacitance of capacitor 849 and/or in some other embodiments of the invention the auxiliary circuit 869, 870, 871, 888, 849B, which is described in greater detail later in this document.

The correct coil is selected for the comparator by means of fets 844 and 845. The selected coil is coupled to the one of the terminals 842 and 843, which has the lower DC voltage. When terminal 843, for example, has a lower potential, as a result of the operation of block 861, the potential (VSS) of the second voltage supply terminal 803 of the filter, the coil to be measured is then 841A. Resistor 847 connects the gate of fet 844 to a terminal which has a higher potential, and resistor 846 connects the gate of fet 845 to a terminal which has a lower potential. Fets 844 and 845 conduct with positive gate control, and thus fet 844 is seen as a small impedance and 845 as an open circuit, whereby the comparator is provided with the potential of the positive pole of coil 841A. In a corresponding manner, if terminal 842 has a lower potential than terminal 843, the potential of the positive pole of coil 841B is coupled to the current meter comparator.

FIG. 8B shows a detail from FIG. 8A for replacing the capacitor 849 by an auxiliary circuit 869, 870 and/or 871 according to an embodiment of the invention. The RCL matrix is then formed of coils and capacitors and resistors, which may, on the other hand, be formed of separate components connected in parallel and/or in series for providing the required inductances, resistances and capacitances in each RCL block 869, 870 and 871. An extreme case of the RCL implementation of the auxiliary circuit is a coupling in which some RCL component, of one or more qualities, has not been coupled to the RCL matrix at all, in which case the number of that component is zero. The numbers of components are generally independent of each other, but in order to accomplish an effect on a certain frequency band, dependencies through the dimensioning of the RCL filters are also possible. Each one of the blocks 869, 870 and 871, provided with appropriate dimensioning of components, is as such suitable for coupling in place of the capacitor 849. RCL circuits obtained by coupling the blocks in pairs or in some other way in series and/or in parallel can also be used in applications according to the embodiments of the invention. For example, the possibility to use serial coupling of blocks 869 and 870 from the auxiliary RCL circuit is illustrated by a dashed line between the blocks from the second coupler of block 869 to the first coupler of block 870.

Block 869 has a capacitance 872, which may consist of a number of components connected in parallel and/or in series, including a case in which the number of capacitors that contain a capacitance is 0. Block 869 also has an inductance 874, which may consist of a number of components connected in parallel and/or in series, including a case in which the number of coils that contain an inductance is 0. In addition, block 869 has a resistance 876, which may consist of a number of components connected in parallel and/or in series, including a case in which the number of resistors that contain a resistance is 0.

Block 870 has a capacitance 882, which may consist of a number of components connected in parallel an&or in series, including a case in which the number of capacitors that contain a capacitance is 0. Block 870 also has an inductance 884, which may consist of a number of components connected in parallel and/or in series, including a case in which the number of coils that contain an inductance is 0. In addition, block 870 has a resistance 886, which may consist of a number of components connected in parallel and/or in series, including a case in which the number of resistors that contain a resistance is 0.

Block 871 has a capacitance 892, which may consist of a number of components connected in parallel and/or in series, including a case in which the number of capacitors that contain a capacitance is 0. Block 871 also has an inductance 894, which may consist of a number of components connected in parallel and/or in series, including a case in which the number of coils that contain an inductance is 0. In addition, block 871 has a resistance 896, which may consist of a number of components connected in parallel and/or in series, including a case in which the number of resistors that contain a resistance is 0.

FIG. 8C illustrates, by way of example, the general use of RCL circuits for accomplishing the desired filtering effect in the auxiliary circuit. By connecting the RCL circuits formed by blocks 869, 870 and 871 in parallel and in series, it is thus possible to form more general RCL circuit entities 888 for coupling in place of the capacitor 849 in order to accomplish the desired effect on the frequency band of the terminal equipment. Two blocks 869 and 870 according to FIG. 8B, connected in series, have been used in the example of FIG. 8C, but in order to accomplish the desired effect the number of blocks connected in series may be larger or smaller, as well as the number of blocks 871 connected in parallel. It may also be stated that blocks 869 and 870 connected in series are in the example of the figure part of an entity, which is parallel with block 871.

FIG. 8D illustrates embodiments of the invention, in which the auxiliary circuit 849B to be coupled in place of the capacitor 849 may be a band-stop filter 889, band-pass filter 890, low-pass filter 891, high-pass filter 898 and/or other RCL matrix 888 for filtering the signal to and/or from the terminal equipment. In practice, the filters 889, 890, 891 and/or 898 can be simply implemented with passive RCL circuits. In said filters 889, 890, 891 and/or 898, in some preferred embodiments of the invention, it is advantageous to use semiconductors in addition to RCL components, actively to intensify certain properties of certain filters, which change the frequency band. The desired component(s) 889, 890, 891, 898, 888 can be selected for switching to between the terminals 899 A and 899 B by means of a switch 899, which may be of the type that is set mechanically, a group of dip switches or an electrically controlled semiconductor-type switching device. Thus, in order to replace the capacitor 849 by an auxiliary circuit 849B, it is possible to couple the terminal 899 A of the auxiliary circuit, for example, in place of the first end of the capacitor 849 and the terminal 899B of the auxiliary circuit 849B in place of the second end of the capacitor 849.

FIG. 9 illustrates the functions of the circuit according to the embodiment of the invention shown in FIG. 8A. The principle of the active microfilter according to the invention in an xDSL application, for example, is to improve the LPF filter shown in FIG. 6 by replacing the passive line capacitance by an active capacitor, in which the capacitance depends on the state of the connection. In FIG. 9, the subscriber has three parallel telephones, from one of which the handset has been lifted as shown in the drawing. All three filters measure the same voltage from the line. In the case of FIG. 9, this voltage is smaller than the threshold voltage. On the basis of this, it is known that at least one of the handsets is off-hook. On the basis of the measurement of the line current, it is possible to specify which one of the handsets is off-hook. The small leakage current that flows through the telephones that are in the off-line position is in the range of 100 μA, which is clearly smaller than the threshold current set for LPF1 and/or LPF2, in the range of 3 mA. Because of this, these filters recognize that they are in the mode “some other handset off-hook” and neutralize the transverse capacitance. Because LPF3 sees a current over 3 mA clearly, LPF3 recognizes being in the mode “this handset off-hook” and configures, for example, the capacitance of capacitor 849 as its transverse additional capacitance, as in the circuit example shown in FIG. 8A.

The telephone line is coupled to the filter input 901, or the corresponding terminals 843 and 842 in FIG. 8A. The filter recognizes the polarity for taking the operating power from the telephone line. In addition, the electric state of the telephone line is examined with the current 908 and voltage measurement apparatus 907, and on the basis of that it is determined whether handsets 910 have been lifted. The line current measuring means 908 correspond to the electric circuit 863 in FIG. 8A and the line voltage measuring means 907 correspond to the electric circuit 862 in FIG. 8A. The filters according to FIG. 8A, which have three operating modes, have been delimited with a dashed line in FIG. 9. i) this handset (910) off-hook, ii) some other handset off-hook and iii) all handsets on-hook. FIG. 9 shows situations in which one of the handsets 910 is off-hook. The filter recognizes the state of the telephone line on the basis of the current and voltage measurement, and is configured to the right mode according to need. Operating power is provided for the coupling by the telephone exchange. Block 861 shown in FIG. 8A actively recognizes the polarity of the input for feeding operating power, whereby the coupling saves 1.4 V as compared to a rectifier implemented with diodes. The coupling loads the telephone line as little as possible, which is advantageous when it may be necessary to couple a large number of filters in parallel. Power consumption of the coupling shown in FIG. 8A is in the range of one microampere, when all the handsets are on-hook, and at the most 20 μA, when one of the handsets is off-hook.

The coupling recognizes the state on the basis of the line current and voltage, which are measured by blocks 862 and 863 of FIG. 8A. On the basis of the state information, the coupling 905 changes the capacitance. The capacitor 849 and fets 848 and 850 form an active capacitor. The rest of the electronics are related to the recognition of the state of the telephone line and the measurement of the currents 862 and the voltages 863 of the coupling. The additional capacitance 849 to be switched is about zero, when some other handset is off-hook (the circuit is broken). In other states the transverse capacitance is clearly different from zero. However, a transverse capacitance always protects the telephone from an xDSL signal.

FIG. 10 shows a method according to an embodiment of the invention for adapting terminal equipment to the subscriber line. The method according to the embodiment of the invention includes at least the following steps, which can be applied once or in continuous operation: the line current is measured 1001 and the line voltage is measured 1002, after which said measured quantities are compared to the corresponding reference values for producing a control signal. The state of the telephone line is determined 1004, and on the basis of that information the capacitor 849 and/or the circuit that contains the impedance (e.g. 888, 889, 890, 891 and/or 898) is connected on-line or off-line. The steps of the method are presented by way of example, without commitment to any particular order, whereby the measurements can also be carried out as parallel and thus independently of each other. In addition, it may be mentioned that the reference values can either be set (1000) once as factory settings, for example, in a manner of checking, or the settings can be implemented adaptively, whereby they can be changed automatically and/or on the basis of an electric signal.

The embodiments of the invention are based on the principle that the terminal equipment can be coupled to the telephone line via a filter connected to it so that the telephone line is loaded as little as possible and the filter changes its electric properties so that the terminal equipment sees the properties of the telephone line as more advantageous with regard to the terminal equipment. The properties of the telephone line and/or the filter mean mainly the electric properties with regard to the transfer and/of filtering of signals used by audio frequency and xDSL applications. The electric properties include resistance, capacitance, inductance, reactance and impedance. There are naturally other electric properties, too, but with regard to the dimensioning of the filter to be connected to the telephone line according to an embodiment of the invention, the electric properties mentioned above must be taken into account.

The transverse capacitance also protects the xDSL modem against so-called ring-trip transients, which occur when lifting the handset off the hook when the telephone rings. Because this transient is relatively high, it may be even in the range of one hundred volts, it is likely that the ADSL modem drops from the connection, if transverse capacitance is not used. Returning the handset on the hook may also cause a transient, which is less harmful, but the microfilter protects from that as well. The filter according to the invention also has the advantage that the telephone remains operational even if the active parts of the filter are damaged as a result of lightning, for example.

The couplings can be made of separate components, but it is advantageous to integrate the circuits on a silicon crystal. Because the required components can be fitted on an area of one square inch only, the filter can be installed as integrated into an adapter or other corresponding connector to be connected to a telephone outlet.

The separation of 40 dB required between xDSL and POTS from the DC to the upper limit of the XDSL band is based on sufficient attenuation of the ring-trip transients. In the off-hook mode, the HPF, which is part of the xDSL modem, is sufficient to eliminate spurious audio-frequency signals. In the off-hook mode, the transverse capacitance requirement is only a fraction of the transverse capacitance needed for ring-trip attenuation. The operation of a ring-trip compliant filter on the audio band is not optimal. By means of a preferred embodiment of the invention, it is possible to adapt the transverse capacitance according to need. An active capacitance which is adapted according to the state of the telephone connection offers a possibility for high attenuation of the stop band and transverse capacitance in the on-hook mode, for example. Correspondingly, an active capacitance can also provide a low capacitance with the same filter in the off-hook mode, for example. In telephone networks coupled with twin pairs, the active filter is much simpler than in telephone networks coupled with single pairs. Thus the components that carry out current measurement, such as the operational amplifier with its voltage settings, can be left out as unnecessary.

In a general case, it is possible that ring-trip transients occur at the telephone exchange end on the same level as at the subscriber's end. Regardless of the switching method, i.e. double or single paired, there are only two potential states of connection in the exchange. In spite of this, a current meter is needed. A corresponding device for the DC input of the telephone exchange is the Thevenin source, which has a voltage of 30-60 V, for example, and an output resistance a little under one k Ω. In the off-hook mode the subscriber loads the exchange, but not sufficiently. The mere DC resistance of the subscriber line may be over said output resistance. In that case, the voltage measured in the loaded state may be over 30 V—higher than the unloaded voltage of a low-voltage exchange.

It is easier to provide operating power to the filter at the exchange end than at the subscriber's end, and therefore the lines need not be loaded more. In a preferred embodiment of the invention, the active electronics of the filter float in relation to the primary of the power source, whereby the filter is in the same common-mode potential as the subscriber line. Then the current meter can be implemented in a manner corresponding to FIG. 8A, which shows the implementation of a subscriber's end to be remote-fed from the telephone exchange. After this, the on/off-hook modes can be interpreted on the basis of the current measurements. The threshold current values can be the same as those at the subscriber's end.

In addition, it may be stated that in a general case, the number of transverse capacitors and/or auxiliary circuits in parallel, with the subscriber line may be effectively more than one, when considering a situation where a plurality of terminal equipment are coupled to a subscriber line, like in the example illustrated by FIG. 9. When it is desired that the coupling of said terminal devices be carried out actively according to one of the embodiments of the invention, it is advantageous to install a separate filter for each unit of terminal equipment, in which case a capacitor 849 and/or a corresponding auxiliary circuit 849B, 869, 870, 871, 888 and switching means 848 and 850 are needed for each filter block 864. The active capacitance is always implemented by two switching means, which are advantageously fets, and by one capacitor or a corresponding auxiliary circuit. For the rest of the coupling, the active electronics remain unchanged.

It is clear to a person skilled in the art that the measurement of the line current can also be carried out in other ways than a coupling based on an operational amplifier, which can thus be replaced e.g. by a current meter coupling based on an amplifier, which consists of separate semiconductors. The switching means of the capacitance coupled actively to the line can also be implemented with other semiconductors than fets or even electromechanically. Then the transverse capacitance is added to the circuit e.g. via a relay or a semiconductor switch on the basis of the state recognition. Power consumption can then be clearly higher than in the solutions according to the preferred embodiments of the invention. In addition, the use of mechanic components, such as relays, does not provide advantage to the preferred embodiments of the invention with regard to the mechanic size and/or switching times

On the basis of the invention it is clear to a person skilled in the art that the line current can also be detected with many different detectors (varistors, current/voltage converters, current/frequency converters, charge-sensitive integrators etc.), and on the basis of the electric signals and the alterations of their levels it is possible to recognize the state of the telephone and switch a suitable capacitance transversely to the telephone line to accomplish the operations of the active filter. It is also clear to a person skilled in the art that the properties of the filter can be customized for each application by using resistances, inductances, capacitances or combinations thereof formed by means of parallel and/or serial couplings to form an auxiliary circuit. An auxiliary circuit or a plurality of them (even different ones) can be connected in parallel and/or in series with the active capacitance, when required. In addition, the auxiliary circuit may also contain active components, such as semiconductors, which are used to intensify the effect of the active capacitance and other components of the auxiliary circuit on the electric properties of the telephone line.

The use of auxiliary circuits also provides a possibility to optimize the electric property of the POTS filter, the switchable impedance, according to the type of the terminal equipment. Currents and voltages typical of the terminal equipment can be recognized, either automatically on the basis of the currents and voltages of the terminal equipment or on the basis of the setting of a separate dip-switch group mechanically or electrically, whereby in order to accomplish the desired electric property, the POTS filter can select the most advantageous active auxiliary transverse circuit in parallel with the subscriber line. Thus the auxiliary circuit can also be an active high-pass, low-pass, band-stop and/or band-pass filter or an operational combination thereof, implemented with semiconductors.

1. A filter for adapting terminal equipment to a subscriber line, characterized in that it comprises means for changing a certain electric property of the filter according to the state of the telephone line.

2. A filter according to claim 1, characterized in that said electric property is transverse to the telephone line.

3. A filter according to claim 1, characterized in that it comprises switching means (848, 850) for switching such a component (849, 849B, 869, 870, 871, 888), which has said electric property, on-line and off-line.

4. A microfilter according to claim 3, characterized in that said switching means (848, 850) are semiconductor switches.

5. A microfilter according to claim 3, characterized in that said switching means (848, 850) are electromechanical relays.

6. A filter according to claim 1, characterized in that said electric property is impedance.

7. A filter according to claim 6, characterized in that for accomplishing said impedance, the microfilter comprises a capacitive component.

8. A filter according to claim 6, characterized in that for accomplishing said impedance, the microfilter comprises an inductive component.

9. A filter according to claim 6, characterized in that for accomplishing said impedance, the microfilter comprises a resistive component.

10. A filter according to claim 1, characterized in that it comprises means for recognizing the polarity of the telephone line.

11. A filter according to claim 10, characterized in that the means used for recognition comprise semiconductors.

12. A filter according to claim 1, characterized in that it comprises means (863) for measuring the line current of the telephone set.

13. A filter according to claim 1, characterized in that it comprises means for recognizing the state information of the telephone line on the basis of the line current.

14. A filter according to claim 1, characterized in that it comprises means for setting the reference value of the line current.

15. A filter according to claim 1, characterized in that for recognizing the state of the telephone line, the filter comprises means for comparing the measured line current to a reference value.

16. A filter according to claim 1, characterized in that it comprises means (862) for measuring the line voltage of the telephone set.

17. A filter according to claim 1, characterized in that it comprises means for recognizing the state information of the telephone line on the basis of the line voltage.

18. A filter according to claim 1, characterized in that it comprises means for setting the reference value for the line voltage.

19. A filter according to claim 1, characterized in that for recognizing the state of the telephone line, the filter comprises means for comparing the measured line voltage to a reference value.

20. A filter according to claim 1, characterized in that it takes its operating power from the subscriber line with an active rectifier (861).

21. A method for adapting terminal equipment to a subscriber line, characterized in that it comprises the steps of
setting (1000) reference values corresponding to the state of the telephone line for the line current and the line voltage
measuring (1001) the line current
measuring (1002) the line voltage
comparing (1003) the measured line voltage and line current to the reference values for forming a control signal
determining (1004) the state of the telephone line on the basis of the measured values and reference values
switching (1005) the impedance on-line/off-line on the basis of the state information.
